(19) United States
(12) Patent Application Publication
(10) Pub. No.: US 2009/0213272 A1
(43) Pub. Date: Aug. 27, 2009

(54) VIDEO PROCESSING APPARATUS AND METHOD FOR PROCESSING VIDEO SIGNAL

(75) Inventor: Takashi Suzuki, Hanyu-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/261,940

(22) Filed: Oct. 30, 2008

(30) Foreign Application Priority Data
Feb. 26, 2008 (JP) 2008-044577

(51) Int. Cl. H04N 5/202

(52) U.S. Cl. 348/674

(57) ABSTRACT

A video processing apparatus includes: a video processor that detects a video type based on an inter-frame difference of a video signal; an automatic image quality adjustment unit that determines an image quality adjusting set value based on the video type detected by the video processor; and an image quality processing unit that performs an image quality adjustment on the video signal based on the image quality adjusting set value, the image quality adjustment including at least one of processes selected from a group of: a brightness enhancement control; an RGB gain control for setting a color temperature; a brightness control; a color enhancement control; a color gain and color tone control; and a nonlinear contrast control.

### CROSS-REFERENCE TO RELATED APPLICATIONS

This application is based upon and claims the benefit of priority from Japanese Patent Application No. 2008-044577, filed on Feb. 26, 2008, the entire content of which are incorporated herein by reference.

### BACKGROUND

1. Field

One embodiment of the present invention relates to a video processing apparatus and a method for processing video signal.

2. Description of the Related Art

As a conventional apparatus, there is known a video processing apparatus that performs a gamma correction suitable for a cinema film source with respect to an input video signal in a case in which the video signal is the cinema film source. An example of such apparatus is disclosed in JP-A-2001-169143.

The conventional video processing apparatus has a cinema film source detection unit for detecting a cinema film source, for example, being subjected to a 2-3 pull-down processing from an input video signal and a gamma correction unit that performs a gamma correction suitable for a video source with respect to the video signal. The gamma correction unit performs the suitable gamma correction for the video film source with respect to the video signal when the cinema film source detection unit detects the cinema film source from the video signal. Thus, the conventional apparatus is configured to automatically perform an optimum gamma correction for the video signal.

However, according to the conventional video processing apparatus, only the gamma correction is performed for the video signal, and an adjustment of a backlight brightness of an LCD (Liquid Crystal Display) has not been suggested, for example, by the document JP-A-2001-169143. Accordingly, there is a problem in that an optimum image quality adjustment for a video source cannot be always achieved. In the case in which a video signal is input from a video player such as a DVD (Digital Versatile Disc) player or an HDD (Hard Disc Drive) player, a video signal for displaying a still image is input to the video processing apparatus when an operation such as a temporary stop is performed in the video player, for example. In this case, there is a problem in that the cinema film source detection unit cannot appropriately detect that the video signal includes the cinema film source being subjected to a 2-3 pull-down processing, and a false detection to determine that the video signal is of other video sources may be performed.

### SUMMARY

One of objects of the present invention is to provide a video processing apparatus and a method for processing video signal which can avoid a false detection caused by a status of an input video signal and can perform an optimum image quality adjustment for a video source included in the video signal.

According to a first aspect of the present invention, there is provided a video processing apparatus including: a video processor that detects a video type based on an inter-frame difference of a video signal; an automatic image quality adjustment unit that determines an image quality adjusting set value based on the video type detected by the video processor; and an image quality processing unit that performs an image quality adjustment on the video signal based on the image quality adjusting set value, the image quality adjustment including at least one of processes selected from a group of: a brightness enhancement control; an RGB gain control for setting a color temperature; a brightness control; a color enhancement control; a color gain and color tone control; and a nonlinear contrast control.

According to a second aspect of the present invention, there is provided a video processing apparatus including: a video processor that detects a video type based on an inter-frame difference of a video signal; an automatic image quality adjustment unit that determines an image quality adjusting set value based on the video type detected by the video processor; an image quality processing unit that performs an image quality adjustment on the video signal based on the image quality adjusting set value, the image quality adjustment including at least one of processes selected from a group of: a brightness enhancement control; an RGB gain control for setting a color temperature; a brightness control; a color enhancement control; a color gain and color tone control; and a nonlinear contrast control; and a display device that is provided with a backlight and displays video image in accordance with the video signal being applied with the image quality adjustment, wherein the image quality processing unit controls the backlight of the display device based on the image quality adjusting set value.

According to a third aspect of the present invention, there is provided a method for processing video signal, the method including: detecting a video type based on an inter-frame difference of a video signal; determining an image quality adjusting set value based on the detected video type; performing an image quality adjustment on the video signal based on the image quality adjusting set value, the image quality adjustment including at least one of processes selected from a group of: a brightness enhancement control; an RGB gain control for setting a color temperature; a brightness control; a color enhancement control; a color gain and color tone control; and a nonlinear contrast control; displaying, by a display device that is provided with a backlight, video image in accordance with the video signal being applied with the image quality adjustment; and controlling the backlight of the display device based on the image quality adjusting set value.

### BRIEF DESCRIPTION OF THE SEVERAL VIEWS OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a schematic view showing a video processing apparatus according to an embodiment of the present invention.

FIG. 2 is a block diagram showing an example of a configuration of the video processing apparatus according to the embodiment.

FIG. 3 is a schematic diagram showing an example of a configuration of an image quality processing unit according to the embodiment.

FIG. 4 is a schematic diagram showing an example of a configuration of an audio processor according to the embodiment.

FIGS. 5A and 5B are flowcharts showing an example of an operation of the video processing apparatus according to the embodiment.

### DETAILED DESCRIPTION

Hereinafter, an embodiment of a video processing apparatus and a method for processing video signal according to the invention will be described below in detail with reference to the drawings.

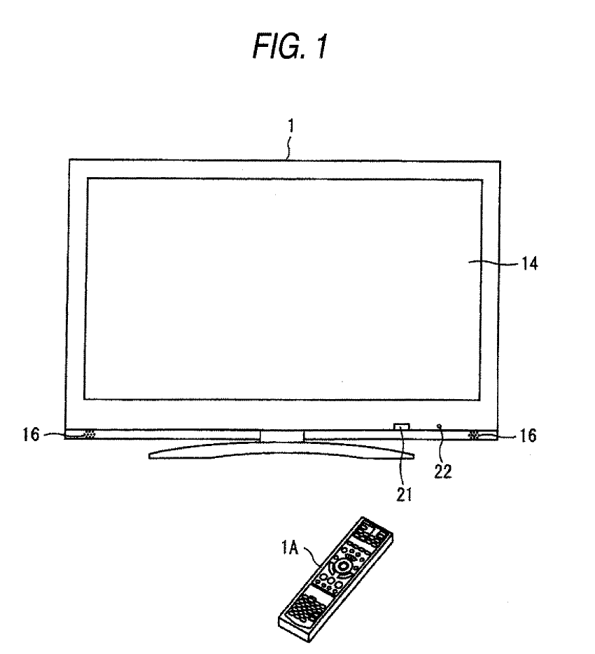

FIG. 1 is a schematic view showing a video processing apparatus 1 according to the embodiment

The video processing apparatus 1 is provided with: a display unit 14 that serves as a television receiver for displaying a video image upon receipt of a digital broadcast wave through an antenna, which is not shown, or displaying a video image upon receipt of a video signal from a video player such as an HDD recorder or a DVD player, which is not shown, and includes an LCD panel that displays a video image on a front face; a speaker unit 16 that outputs sound; a light receiving unit 21 that receives an operating signal using infrared rays transmitted from a remote controller 1A having a plurality of operating buttons; and an optical sensor 22 configured by a photodiode for measuring an illuminance of an external environment. The video processing apparatus 1 is further provided with: an interface panel having an antenna terminal, an external input terminal and a plurality of switches (not shown) on a back face; and electronic components including a CPU (Central Processing Unit) which serves to process a video signal or an audio signal and to control other components, an RAM (Random, Access Memory), an ROM (Read Only Memory) and an HDD.

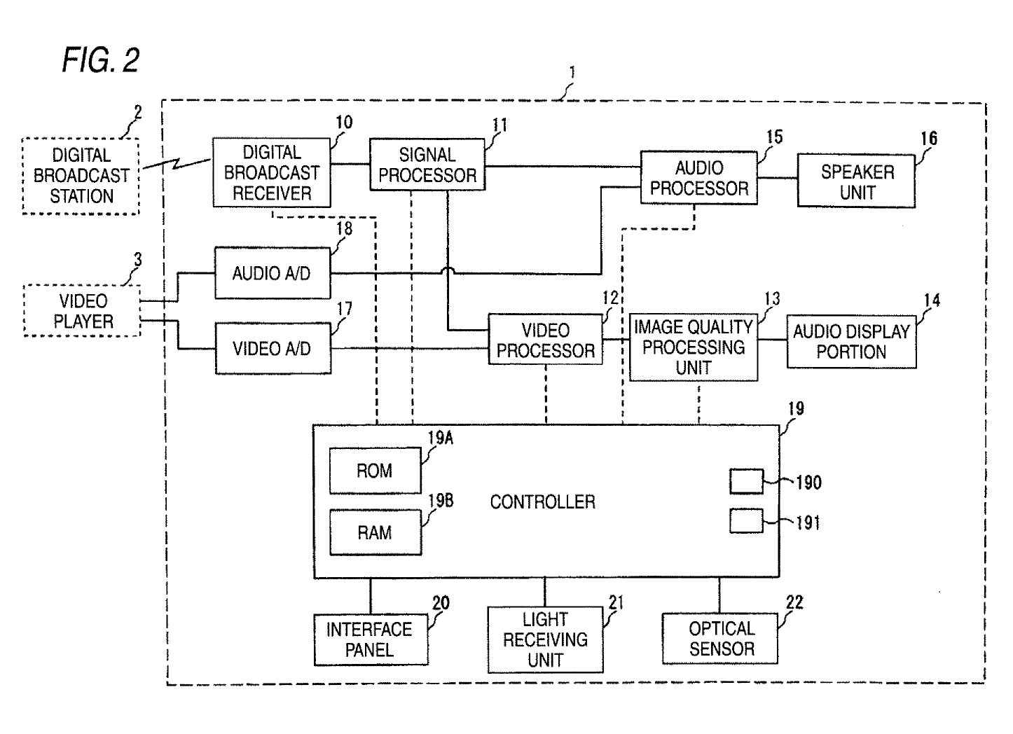

FIG. 2 is a block diagram showing an example of a configuration of the video processing apparatus according to the embodiment of the invention.

The video processing apparatus 1 includes a digital broadcast receiver 10 that receives a broadcast signal transmitted from a digital broadcast station 2, and the digital broadcast receiver 10 is connected to a signal processor 11. The signal processor 11 is connected to an audio processor 15 and a video processor 12, separates the received broadcast signal into an audio signal and a video signal, and outputs the audio signal to the audio processor 15 and outputs the video signal to the video processor 12.

The audio processor 15 is connected to the speaker unit 16, and the video processor 12 is connected to the display unit 14 configured by a CRT or a liquid crystal display panel through an image quality processing unit 13 for adjusting an image quality. The audio processor 15 controls a tone of the input audio signal. The image quality processing unit 13 controls the image quality of the input video signal and controls a backlight of the display unit 14.

The video processing apparatus 1 includes a video analog/digital converter (A/D) 17 and an audio A/D 18 which receive video and audio signals transmitted from a video player 3 connected to an external input terminal, which is not shown. The video and audio signals input to the video A/D 17 and the audio A/D 18 are converted from analog signals into digital signals by the video A/D 17 and the audio A/D 18, and output to the video processor 12 and the audio processor 15 respectively.

The video processing apparatus 1 includes a controller 19 that controls other components through a control line shown by a dotted line in FIG. 2. An interface panel 20 configured by an operating switch, the light receiving unit 21 for receiving an operating signal of an infrared ray of the remote controller 1A, and the optical sensor 22 for detecting an illuminance level of an external environment are connected to the controller 19.

The controller 19 has an ROM 19A for storing a program for controlling the components, an RAM 19B for temporarily storing information and supporting an operation by the controller 19, an automatic image quality adjustment unit 190 and a user image quality adjustment unit 191.

The automatic image quality adjustment unit 190 determines an image quality adjusting set value based on a video type output through an analysis of the video signal input by the video processor 12 and determines an image quality adjusting set value based on the illuminance of the external environment which is measured by the optical sensor 22, and controls the image quality processing unit 13 based on the image quality adjusting set value thus determined. The automatic image quality adjustment unit 190 is operated at a time interval on a unit of a field of video information and adjusts an image quality of video information input dynamically. The automatic image quality adjustment unit 190 determines a tone adjusting set value together with the tone adjusting set value and controls the audio processor 15 based on the tone adjusting set value thus determined. The image quality adjustment indicates one of a brightness enhancement control, an RGB gain control for setting a color temperature, a brightness control, a color enhancement control, a color gain and color tone control and a nonlinear contrast control or their combination. The tone adjustment indicates one of an equalizer control, a surround control and a bass correcting control or their combination.

The user image quality adjustment unit 191 determines the image quality adjusting set value or the tone adjusting set value based on the operating signal received by the interface panel 20 or the light receiving unit 21 and controls the image quality processing unit 13 based on the image quality adjusting set value thus determined, and controls the audio processor 15 based on the tone adjusting set value thus determined. The user image quality adjustment unit 191 displays a menu for an image quality adjustment (not shown), for example, and always applies an image quality adjusting set value determined in the menu for an image quality adjustment after the end of the image quality controlling operation.

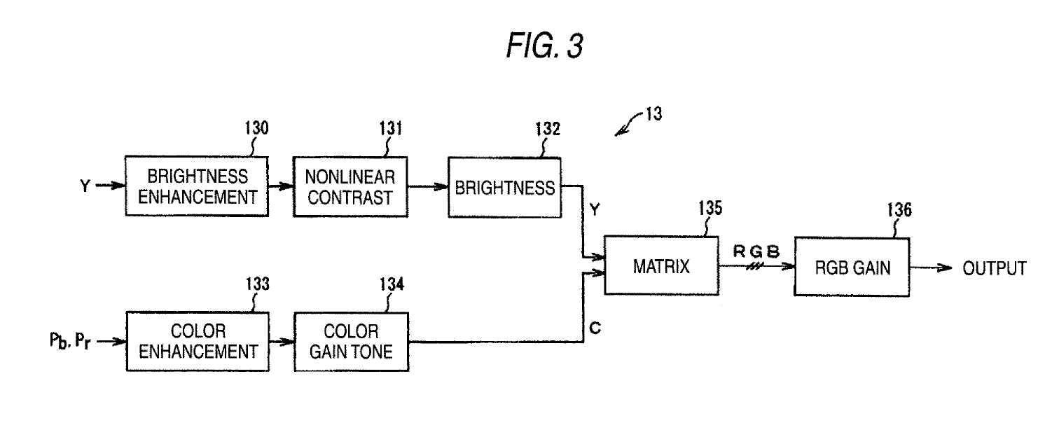

FIG. 3 is a schematic diagram showing an example of a configuration of the image quality processing unit according to the embodiment of the invention.

The image quality processing unit 13 has a brightness enhancement 130 for inputting a component signal as a video signal and processing a brightness signal Y, a nonlinear contrast 131, a brightness 132, a color enhancement 133 for processing color difference signals P_{b} and Pᵣ, a color gain tone 134, a matrix 135 for converting, into RGB signals, the brightness signal Y and a color difference signal C which are processed in each portion, and an RGB gain 136 for adjusting a gain of the RGB signal to set a color temperature and outputting the signal to the display unit 14.

The brightness enhancement 130 performs a contour correction over the brightness signal Y to highlight a visibility, and dynamically reflects the image quality adjusting set value of the automatic image quality adjustment unit 190 and statically reflects the image quality adjusting set value of the user image quality adjustment unit 191. The nonlinear contrast 131 dynamically reflects the image quality adjusting set value of the automatic image quality adjustment unit 190 to perform a nonlinear contrast adjustment. The brightness 132 reflects the image quality adjusting value of the automatic image quality adjustment unit 190 to dynamically adjust a value of the brightness signal and reflects the image quality adjusting value of the user image quality adjustment unit 191 to statically adjust the value of the brightness signal.

The color enhancement 133 performs a contour correction over the color difference signals P_{b} and Pᵣ to highlight a visibility, and dynamically reflects the image quality adjusting set value of the automatic image quality adjustment unit 190 and statically reflects the image quality adjusting set value of the user image quality adjustment unit 191. The color gain tone 134 adjusts a color gain of the color difference signal to dynamically reflect the image quality adjusting set value of the automatic image quality adjustment unit 190 and to statically reflect the image quality adjusting set value of the user image quality adjustment unit 191. The configuration of the image quality processing unit 13 is not limited to the foregoing but a configuration may be added properly.

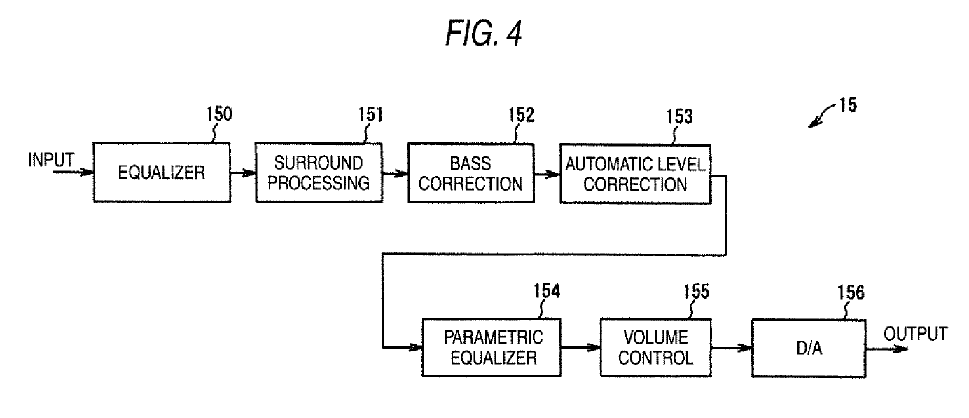

FIG. 4 is a schematic diagram showing an example of a configuration of the audio processor 15 according to the embodiment of the invention.

The audio processor 15 includes an equalizer 150 for inputting an audio signal and adjusting five bands of 100 Hz/330 Hz/1 kHz/3.3 kHz/10 kHz, a surround processing 151 for switching a wide surround or a cinema surround, a bass correction 152 having a frequency and a level which are variable, an automatic level correction 153 for normalizing an amplitude of an audio signal, a parametric equalizer 154 for performing an adjustment corresponding to a characteristic of the speaker unit 16, a volume control 155 for determining a gain of the audio signal based on a volume set value, and a digital/analog converter (D/A) 156 for performing a digital/analog conversion over the audio signal and outputting the analog signal to the speaker unit 16.

Although the equalizer 150 and the volume control 155 can reflect the tone adjusting set value of the user image quality adjustment unit 191, the other portions are operated by reflecting only the tone adjusting set value of the automatic image quality adjustment unit 190. The configuration of the audio processor 15 is not limited to the foregoing but a configuration may be added properly.

An operation of the video display apparatus 1 according to the embodiment of the invention will be described below with reference to the drawings.

A digital broadcast wave transmitted from the digital broadcast station 2 is input to the digital broadcast receiver 10 through an antenna which is not shown.

The digital broadcast receiver 10 demodulates the received signal through a demodulator (not shown) corresponding to a ground wave digital broadcast modulating method, extracts a data sequence (a transport stream) based on MPEG2 standards and outputs the data sequence to the signal processor 11, for example.

The data sequence (the transport stream) input to the signal processor 11 is separated into an audio signal (digital) and a video signal (digital) by an MPEG2 decoder (not shown), for example, and the audio signal is output to the audio processor 15 and the video signal is output to the video processor 12.

The video processor 12 detects a inter-frame difference of the input video signal (digital) and detects a cinema film source obtained by performing a 2-3 pull-down processing over a video source, other normal video sources or a still image and outputs a video type signal to be a detection result to the automatic image quality adjustment unit 190.

The automatic image quality adjustment unit 190 determines an image quality adjusting set value and a tone adjusting set value based on the video type signal. The user image quality adjustment unit 191 determines a picture adjusting set value and a tone adjusting set value based on the operation contents of the interface panel 20 or the remote controller 1A.

Next, the image quality processing unit 13 adjusts an image quality of the video signal based on the image quality adjusting set value and then converts the video signal into an analog signal and outputs the analog signal to the display unit 14 configured by a CRT or an LCD where appropriate.

The audio processor 15 controls and adjusts a tone of the input audio signal (digital) based on the tone adjusting set value and then carries out a processing of performing a conversion into an analog audio signal, and outputs the analog audio signal to the speaker unit 16.

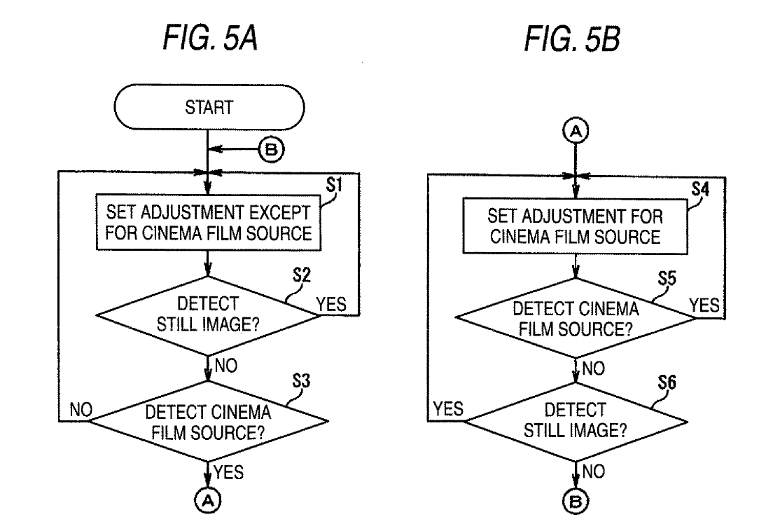

FIGS. 5A and 5B are flowcharts showing an example of an operation of the video processing apparatus 1 according to the embodiment of the invention.

When a power supply of the video processing apparatus 1 is turned ON, the automatic image quality adjustment unit 190 first operates the image quality processing unit 13 and the audio processor 15 based on the image quality adjusting set value and the tone adjusting set value in the case in which the video signal is not the cinema film source as shown in FIG. 5A (S1).

Next, a still image is detected through a decision whether the same field continues in the video processor 12 (S2). If the still image is not detected (S2; No), the video processor 12 subsequently detects a cinema film source (S3). If the still image is detected at the Step S2 (S2; Yes), the processing returns to the Step S1.

If the cinema film source is detected at the Step S3 (S3; Yes), the image quality processing unit 13 and the audio processor 15 are operated based on the image quality adjusting set value and the tone adjusting set value in the case in which the video is the cinema film source as shown in FIG. 5B (S4). If the cinema film source is not detected (S3; No), the processing returns to the Step S1.

Subsequently to the Step S4, the video processor 12 detects the cinema film source (S5). If the cinema film source is not detected (S5; No), the video processor 12 then detects a still image (S6). If the cinema film source is detected at the Step S5 (S5; Yes), the processing returns to the Step S4.

If the still image is not detected at the Step S6 (S6; No), the processing returns to the Step S1 in FIG. 5A in which the image quality processing unit 13 and the audio processor 15 are operated based on the image quality adjusting set value and the tone adjusting set value in the case in which the video is not the cinema film source (S1). If the still image is detected (S6; Yes) the processing returns to the Step S4.

According to the embodiment, the video processor 12 determines the video source by a process shown in FIGS. 5A and 5B in the case in which the still image is detected. Therefore, the automatic image quality adjustment unit 190 can perform an accurate image quality adjustment setting operation based on the video source.

The user image quality adjustment unit 191 controls over a part of adjustments provided by the image quality processing unit 13 and the audio processor 15, while the automatic image quality adjustment unit 190 controls over most of the adjustments provided by the image quality processing unit 13 and the audio processor 15. Therefore, it is possible to perform an appropriate adjustment for various video sources and to control an illuminance level of a backlight of the display unit 14.

The operation of the video processor 12 is not limited to the operation shown in FIGS. 5A and 5B but may be appropriately configured in advance.

As described above with reference to the embodiment, there is provided a video processing apparatus and a method for processing video signal that are capable of avoiding a false detection caused by a status of an input video signal and to perform an optimum image quality adjustment for a video source.

What is claimed is:

1. A video processing apparatus comprising:
a video processor that detects a video type based on an inter-frame difference of a video signal;
an automatic image quality adjustment unit that determines an image quality adjusting set value based on the video type detected by the video processor; and
an image quality processing unit that performs an image quality adjustment on the video signal based on the image quality adjusting set value, the image quality adjustment including at least one of processes selected from a group of: a brightness enhancement control; an RGB gain control for setting a color temperature; a brightness control; a color enhancement control; a color gain and color tone control; and a nonlinear contrast control.

2. The apparatus according to claim 1, wherein when a still image is input as the video signal, the video processor determines that the video signal is of a predetermined video type.

3. The apparatus according to claim 1, wherein when a still image is input as the video signal, the automatic image quality adjustment unit determines the image quality adjusting set value in accordance with the video type detected before the still image is input.

4. The apparatus according to claim 1 further comprising an audio processor that performs a tone adjustment on an audio signal related to the video signal based on the video type detected by the video processor, the tone adjustment including at least one of processes selected from a group of: an equalizer control; a surround control; and a bass correcting control.

5. A video processing apparatus comprising:
a video processor that detects a video type based on an inter-frame difference of a video signal;
an automatic image quality adjustment unit that determines an image quality adjusting set value based on the video type detected by the video processor;
an image quality processing unit that performs an image quality adjustment on the video signal based on the image quality adjusting set value, the image quality adjustment including at least one of processes selected from a group of: a brightness enhancement control; an RGB gain control for setting a color temperature; a brightness control; a color enhancement control; a color gain and color tone control; and a nonlinear contrast control; and
a display device that is provided with a backlight and displays video image in accordance with the video signal being applied with the image quality adjustment,
wherein the image quality processing unit controls the backlight of the display device based on the image quality adjusting set value.

6. The apparatus according to claim 5, wherein when a still image is input as the video signal, the video processor determines that the video signal is of a predetermined video type.

7. The apparatus according to claim 5, wherein when a still image is input as the video signal, the automatic image quality adjustment unit determines the image quality adjusting set value in accordance with the video type detected before the still image is input.

8. The apparatus according to claim 5 further comprising an audio processor that performs a tone adjustment on an audio signal related to the video signal based on the video type detected by the video processor, the tone adjustment including at least one of processes selected from a group of: an equalizer control; a surround control; and a bass correcting control.

9. A method for processing video signal, the method comprising:
detecting a video type based on an inter-frame difference of a video signal;
determining an image quality adjusting set value based on the detected video type;
performing an image quality adjustment on the video signal based on the image quality adjusting set value, the image quality adjustment including at least one of processes selected from a group of: a brightness enhancement control; an RGB gain control for setting a color temperature; a brightness control; a color enhancement control; a color gain and color tone control; and a nonlinear contrast control;
displaying, by a display device that is provided with a backlight, video image in accordance with the video signal being applied with the image quality adjustment; and
controlling the backlight of the display device based on the image quality adjusting set value.
